(19) United States
(12) Patent Application Publication
(10) Pub. No.: US 2003/0191946 A1
(43) Pub. Date: Oct. 9, 2003

(54) System and method controlling access to digital works using a network

(76) Inventors: Anthony R. Auer, Toronto (CA); Stanley J. Simmons, Kingston (CA); Eric C.H. Yeung, Toronto (CA)

Correspondence Address: DOWELL & DOWELL PC, SUITE 309, 1215 JEFFERSON DAVIS HIGHWAY, ARLINGTON, VA, 22202

(21) Appl. No.: 10/297,836

(22) PCT Filed: Jun. 12, 2001
(86) PCT No.: PCT/CA01/00883

(51) Int. Cl. H04L 9/00

(52) U.S. Cl. 713/182

(57) ABSTRACT

Controlled access to digital works using a network employs a dynamically updated client identification code to uniquely identify the client to a server, a content identification code to identify digital work, and a client software module as an agent of the server. An encrypted secret or unencrypted authorization code allowing access to the data content is transmitted to the client. Transmitting an encrypted secret to the client over an insecure communications network supports encryption of the digital work. A database association provides for a software license environment for copies of different digital works and at least one machine. Distributing supplemental data content (e.g. advertising) from one or many servers to a client involves contacting an authentication server to determine whether access to the primary digital work should be provided to the client, retrieving from a data content server the supplemental data content and transmitting the supplemental data content to the client for display.

### TECHNICAL FIELD

The field of the invention relates generally to a system and method of controlling access to software (or other digital media accessible by software) using a network to allow remote authorization.

### BACKGROUND ART

It is known in the art that unauthorized use of software applications, (and digital media accessed by such applications) is difficult to prevent. However, the availability of network connections is becoming widespread and this can provide a client/server mechanism by which to improve control of access to such works. In this client/server system, a consumer has an electronic device, such as a video game console or general purpose personal computer, which is the client, and which is capable of communicating over the internet with a server.

The server may act as a database of licensing and access rights for authorizing remote access to the desired work. Such works may be acquired for installation through any distribution method, including over the internet itself. The distributor or owner of the work may wish to completely prevent access to unpaid unauthorized users, or may wish to provide restricted access (e.g. a limited trial period). There is a need for a system and method which provide flexible access rights to such digital works.

It is further known in the art that most resident software running on an insecure client machine is inherently untrustworthy, in the sense that it is not exceedingly difficult for a party to substitute their own programs in order to allow the party to perform unauthorized actions. The client/server mechanism therefore wishes to rely only on the actions of trusted software modules that act as agents of the server. Such trusted modules may or may not normally completely reside on the client. Any temporarily installed software component that represents the interests of the server, and which is delivered over the internet, is called a remote agent.

It is also known in the art that the internet is not an inherently secure environment: it must be assumed that any data transmitted over the internet between a client and server can be intercepted and analyzed. Therefore secure cryptographic techniques are required when transmitting information that should remain secret (i.e., which should remain known only to the server or one of its agents). Such generic cryptographic techniques include block or stream encryption under secret keys, as well as key exchange protocols.

To prevent an attacker from directly modifying the desired application programs to induce desired behaviour (e.g. to acquire unauthorized access), encryption of all or part of those programs may be used, but a decryption key must then be provided (normally to a remote agent) to decrypt the programs in order to grant authorized access. This in turn necessitates a method by which such a secret can be securely transferred over the insecure network.

Finally, the client/server authorization method naturally allows a conduit for additional information to be provided to the consumer on launch of the digital content in question. This creates an opportunity for directed consumer advertisement.

### DISCLOSURE OF THE INVENTION

In one aspect the invention provides a method and system of providing controlled access to digital works by communicating over an insecure network. The insecure communications network comprises a client and server. The method comprises employing a client identification code to uniquely identify the client to the server; employing a content identification code to identify the digital work; transmitting from the client to the server the client identification code; and evaluating access rights of the client to the digital work at the server by checking the client identification against a database comprising access rights for a plurality of clients for the data content; and if the access is authorized, transmitting to the client a secret used to gain acces to the digital work.

In the first aspect, the method may include providing a software module at the client for coordinating access-rights checking with the server, said software module being attached to form an integral part of any software application digital works.

In the method of the first aspect, the step of transmitting may be performed when on-line connection to the authorization server is possible. When on-line connection to an authorization server is not possible, the method may include locally evaluating at the client a set of time-limited access rights stored locally, said locally stored access rights having been previously digitally signed and transmitted by the server, and if said access is authorized, allowing off-line access to the digital work.

In the first aspect, the method may include updating the dynamic client identification code so that copied off-line access rights will be invalidated at subsequent server contacts. The method may include leaving in local storage at the client a set of access rights digitally signed by the server to allow subsequent off-line usage. The method may include encrypting the secret or authorization code prior to transmitting it.

In another aspect, the invention provides a method for creating a client identification code by composing the identification code as a concatenation of a fixed identifier unique to the server, a changeable sequence number incremented by the server, and a changeable pseudo-random number; and at every authorization contact of a client with a server, updating the client and server database with a modified identification code.

In another aspect, the invention provides a method and system of transmitting in encrypted fashion to the client a secret over an insecure communications network. The insecure communications network comprises a client and server. The method comprises establishing a composite session key common to both the client and the server where the client and the server each provide one portion towards construction of the composite key, where the composite key cannot be constructed by any other party not knowing one of the two provided portions; encrypting the secret with the composite session key to form an encrypted secret; transmitting from the client to the server an authentication message, where the authentication message is known only to the client and the server within a time limit, and to no other party within the time limit; transmitting the encrypted secret from the server to the client if and only if the authentication message is valid and is received by the server within the time limit; and decrypting the encrypted secret at the client using the session key to recover the secret.

In still yet another aspect, the invention provides a database association in a software license environment for multiple copies of different digital works and at least one machine. The database association has a first record for a digital work license owner; a second record for new digital work licenses controlled by the owner which have not yet been assigned to a machine; a third set of records for machines controlled by the owner; for each machine in the third set, a set of records of installed digital works associated with the machine; and for each record in the set of records of installed digital works a record for a license relating to the installed digital work.

The database allows manipulation and access of records therein when (i) a record for the owner does exist in the database and a query is being made regarding status of the owner to the database; (ii) a record for the owner exists in the database and the owner is attempting to access a digital work for which a record is not in the database; and (iii) a record for the owner exists in the database and the owner is attempting access a digital work for which there is a record in the database.

In still yet another aspect, the invention provides a method and system of distributing supplemental data content (e.g. advertising) from the server to the client or other clients in a communications network where a client communicates with a number of types of servers. The method comprises when the client is executing a program, contacting an authentication server to determine whether the primary data content should be provided to the client; and retrieving from a data content server the supplemental data content and transmitting the supplemental data content to the client for display on the client.

### BRIEF DESCRIPTION OF THE DRAWINGS

The foregoing and other aspects of the invention will become more apparent from the following description of specific embodiments thereof and the accompanying drawings that illustrate, by way of example only, the principles of the invention. In the drawings, where like elements feature like reference numerals (and wherein individual elements bear unique alphabetical suffixes):

FIG. 1 is a block diagram of an exemplary communications network in which the preferred embodiment of the invention may reside;

FIG. 2 is a block diagram of a client and server communicating over an insecure network associated with the embodiment of FIG. 1;

FIG. 3 is a block diagram of a modified client/server network of FIG. 2;

FIG. 4 is a block diagram of a client in a client/server network operating after initiation of a process associated with the embodiment of FIG. 3;

FIG. 5 is a block diagram of another aspect of the embodiment showing a secure transmission protocol;

FIG. 6 is another block diagram of another secure transmission protocol for the aspect of the embodiment of FIG. 5;

FIG. 7 is a block diagram of relationships existing amongst object classes in a database associated with another aspect of an embodiment;

FIG. 8 is a flow chart of a system states for objects related to another aspect of an embodiment of FIG. 7;

FIG. 9 is a block diagram of an authentication process for a client in a multiple client/server network in yet another aspect of an embodiment of the invention;

FIG. 10 is another block diagram of a process related to an aspect of the embodiment of FIG. 9; and

FIG. 11 is another block diagram of a process related to an aspect of the embodiment of FIG. 9.

### MODES FOR CARRYING OUT THE INVENTION

The description which follows and the embodiments described therein, is provided by way of illustration of an example, or examples of particular embodiments of the principles of the present invention These examples are provided for the purposes of explanation, and not limitation, of those principles and of the invention. In the description, which follows, like elements are marked throughout the specification and the drawings with the same respective reference numerals.

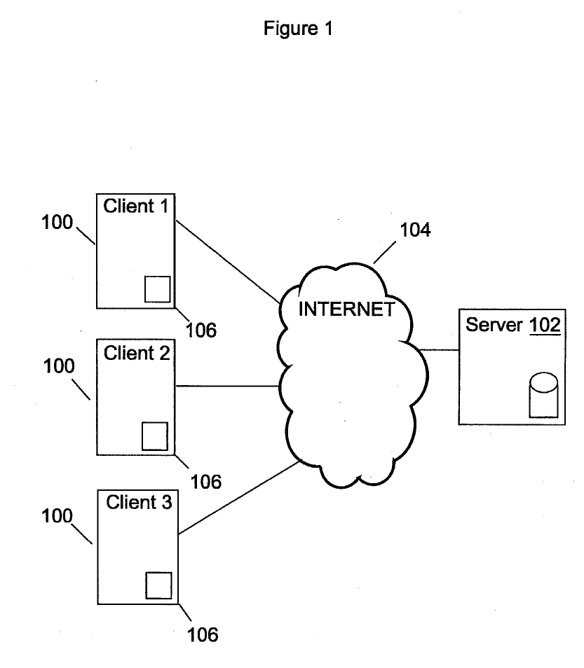

Referring to FIG. 1, in order to provide secure authentication and controlled application program startup, it is necessary to employ secure software. Part of this secure software will reside and execute inside a protected computer called a “server” 102 that is connected to user PCs 100 through a communications network, such as the Internet (“web”) 104. Many types of connections to the internet 104 are known in the art, including modem connections and cable connections. The remaining part of the secure software must execute on user PC 100 (or console). Ideally the user PC software should remain temporarily on the user PC for the purposes of application startup. This software is identified as “remote agent” (or “RA”) 106. Alternately, bcal permanently-resident software may act in place of a temporary remote agent, but with reduced security.

The remote agent 106 acts as the remote presence of the secure server software, and must authenticate itself to the server before application program startup will be authorized by the server. Once the RA 106 authentication process is satisfied, if encryption has been used, a media “key” will be passed to the RA 106 who will then use it to decrypt an encrypted portion of the application. Once decrypted, the application will be started by the RA. The media “key” (if employed) must be encrypted to prevent an eavesdropper from decoding its contents.

The RA 106 is transmitted from the server to the client, and is installed by the initialization program for execution on the user PC. Unlike typical software “installation” process that PC users are familiar with, the RA 106 installation process is dynamic, requiring only a fraction of a second to complete.

The RA 106 performs the following activities:

a) extracting the unique ID of the user PC;

b) optionally, verifying that the application and INIT program are intact and unhampered;

c) optionally, verifying that a valid operating system is present; like a familiar windows-based interface;

d) optionally, verifying that it itself has not been modified since installation;

e) computing a unique authentication response to verify itself and the PC's ID to the server; and

f) if encryption of the digital work has been employed, securely (secretly) receiving the media key from the server.

Also, the RA 106 must be preferably resistant to attacks from programs residing on the user PC which attempt to take the media key.

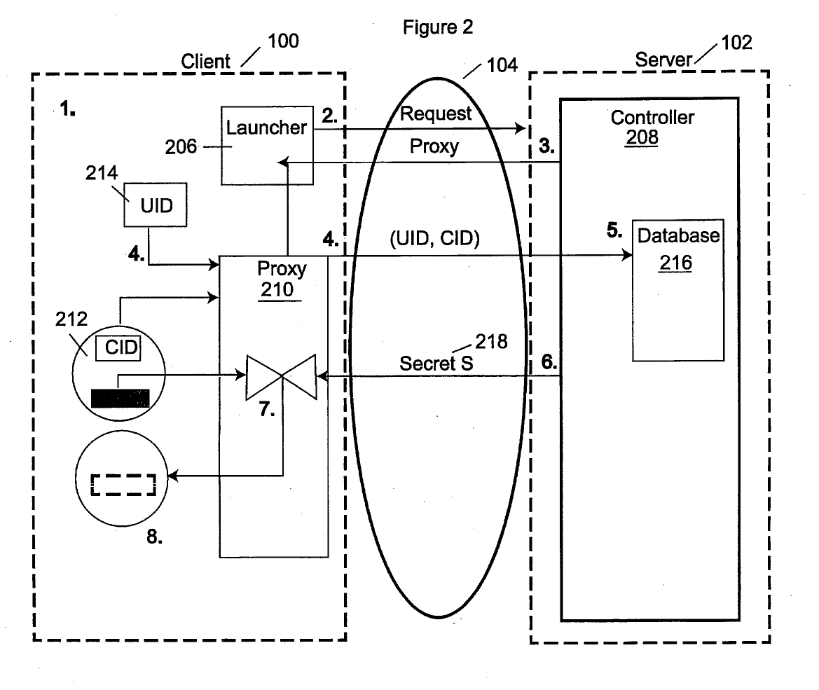

Referring to FIG. 2, client 100 communicates with server 102 through insecure network 104. It can be appreciated that Proxy 210 below is equivalent to RA 106 above. To control access, the embodiment performs the following steps:

1. The user begins to attempt to access the secured digital work, which causes Launcher 206 to begin executing.

2. Launcher 206 contacts Controller 208 through communications network 104.

3. Controller 208 downloads Proxy 210 to the Launcher 206, which then invokes Proxy 210.

4. Proxy 210 extracts and transmits to Controller 208 an identifier of the digital content, CID 212, and the unique user-device identifier UID 214.

5. The Controller 208 checks CID 212 and UID 214 against database 216 of previously recorded access rights.

6. If access is to be granted, Controller 208 initiates method M by which Controller 208 transfers secret S 218 to the Proxy 210 (or transfers missing content encrypted under secret S 218).

7. Proxy 210 uses secret S 218 to decrypt the content (if encryption has been used).

8. Proxy 210 erases secret S 218, then allows user access to the decrypted content.

It can be appreciated that other variations may be incorporated in this aspect of the embodiment. Specifically, the Launcher 206 may subsume the functions of the Proxy 210.

Identifiers UID 214 and CID 212 may be sent unencrypted or encrypted across the network 104 using methods known in the art.

Also, before the secret S 218 is transferred to the Proxy 210, Proxy 210 may generate and send a message to the Controller to authenticate itself to the Controller 208 as its valid proxy.

The Proxy 210 may have various levels of security, producing varying levels of degrees of difficulty for an attacker to discover the secret S 218. A more secure Proxy 210 would be unique, and not used twice. For example, Proxy 210 may generate an authentication response which is unique on each instance.

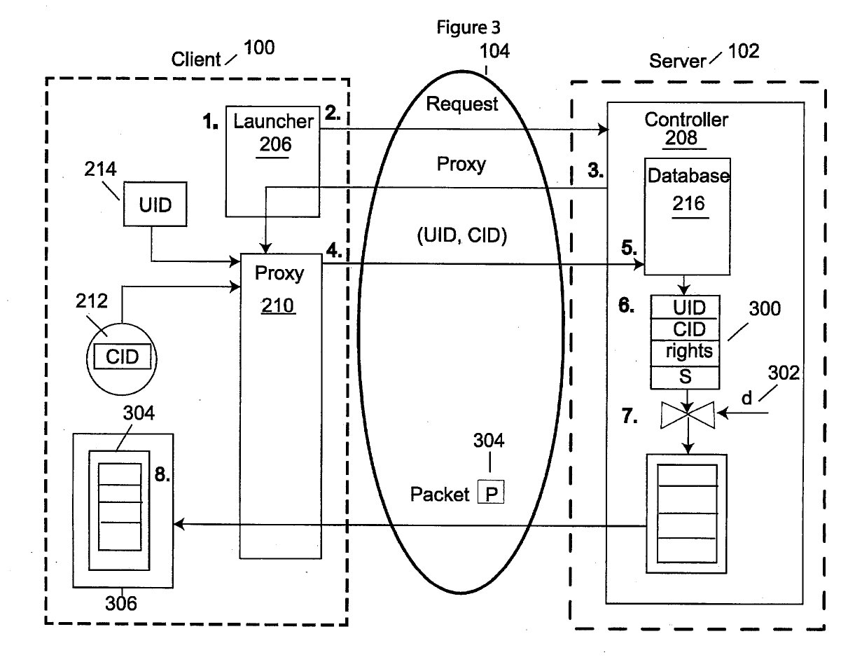

Further, referring to FIG. 3, the operation of the system of FIG. 2 may be modified such that the server is not contacted at every launch. Therein, the Launcher 206 will be responsible for enforcing access rights for the launches in which the Controller 208 is not contacted. To support this, a Proxy 210 must be sent at least for the first launch and must leave behind in non-volatile storage a data packet that will allow the Launcher 206 to decide on whether or not to grant access on subsequent launches in which the Controller 208 is not contacted.

The procedure for the first launch of this alternative embodiment is as follows:

1. The user launches the digital work, which causes the Launcher 206 to begin executing.

2. Launcher 206 contacts the Controller 208 over network 104.

3. Controller 208 downloads the Proxy 210 to Launcher 206, which then invokes Proxy 210.

4. Proxy 210 extracts and returns to the Controller 208, CID 212, and a unique UID 214.

5. The Controller 208 checks CID 212 and UID 214 against a database 216 of previously recorded access rights.

6. The Controller constructs a packet 300 that embeds within it the identifiers CID 212, and UID 214, the current access rights for that pair of identifiers, and the secret S 218.

7. Controller 208 then encrypts this packet 300 using its private signature key d 302, to create signed packet P 304, and transmits that packet to the Proxy. Signature key d 302 is the private half of a signature scheme (for example RSA) key pair (e,d).

8. Proxy 210 records the packet P 304 in nonvolatile memory 306 on the user device.

In the alternative, Launcher 206 may provide any or all the functions of the Proxy 210 in the above steps, and by doing so to avoid the downloading of the Proxy 210 even on the first launch. Such a system is less secure in that it is more vulnerable to users discovering the secret S 218.

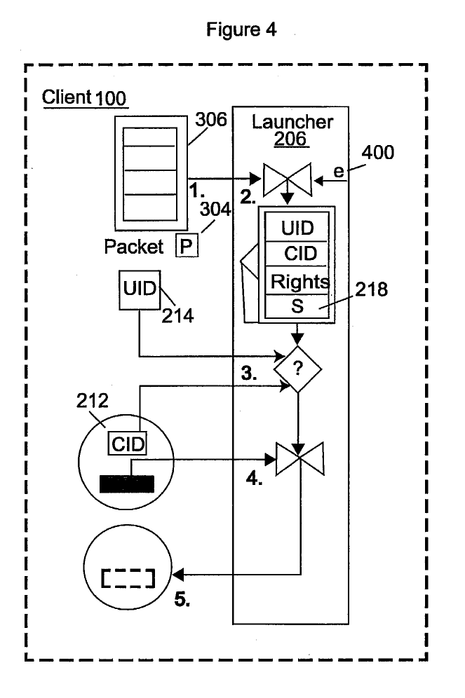

Referring to FIG. 4 for subsequent launches of the application, the procedure is as follows.

1. The client 100 launches the digital work, which causes Launcher 206 to begin executing. The Launcher 206 sees the presence of the Controller-signed signed packet P 304 in non-volatile memory 306.

2. Launcher 206 retrieves the packet P 304 from non-volatile memory 306, decrypts it using the known inverse e 400 of the Controller's signature key d 302, then extracts the values of CID 212 and UID 214 contained within that packet, along with the access rights.

3. Launcher 206 now retrieves identifiers CID 212 and UID 214 from the digital work and the user device, respectively, and compares them to the access rights retrieved earlier from non-volatile storage.

4. If the access values match, Launcher 206 is assured that Controller 208 has previously configured access for this CID 212 and UID 214 combination. If the access rights are still in effect (they have not expired), Launcher 206 will grant access. If encryption has been employed, the Launcher 206 then extracts S 218 from the packet P 304 and uses S 218 to decrypt the digital content to be accessed by the user.

5. Launcher 206 erases secret S 218, and allows access to the decrypted digital content.

Another aspect of the embodiment provides a method M for transferring a long-lived secret S 218 from a principal to its proxy agent over an insecure link. Specifically, the aspect utilizes a time-limited secret Z known to principal and proxy agent so that the principal may authenticate the proxy agent as the recipient of secret S. The method M employs encryption of secret S 218 by a one-time-use time-limited-secret key Kₛ to prevent an eavesdropper from capturing the value of S 218 while it is transferred over the insecure link. This one-time-use secret key Kₛ is established between principal and proxy using a method suitable for establishing such keys over an insecure link when the parties have had no previous communication, for example, by using the Diffie-Hellman protocol or one of its variants.

The secret value Z is known solely to the principal and its proxy agent during the time limit T. This may be pre-arranged by a transfer of the secret Z between proxy agent and principal over a secure link at some time prior to using the insecure link. The time-limit on the secret-keeping ability of the proxy agent only begins at a predetermined later time. This method can, for example, find application in networked computer systems where a remote software agent will have only time-limited secret-keeping ability. In such an application, secret Z can be securely transferred between the remote agent (the proxy agent) and its principal prior to dispatch of the agent to its remote location. Once the agent is dispatched, the clock would begin to tick on its secret-keeping ability.

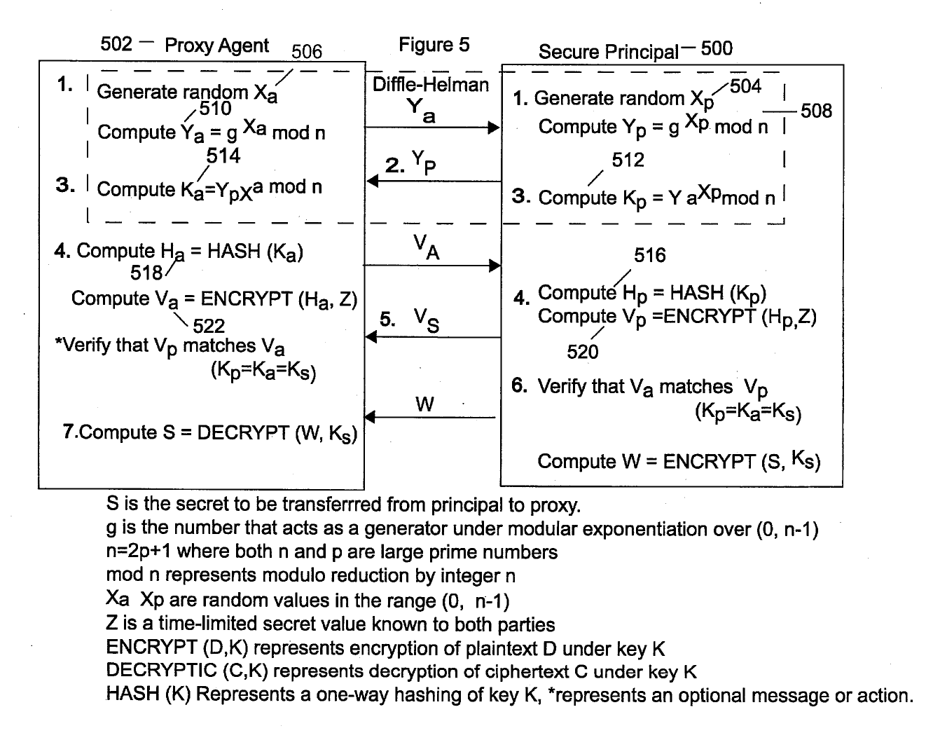

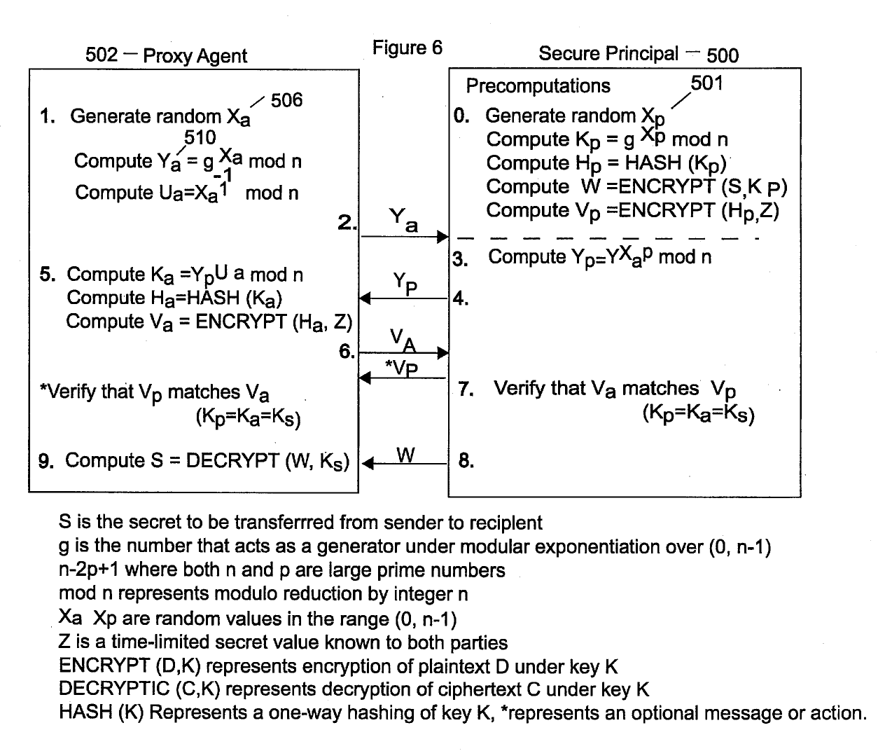

Referring to FIGS. 5 and 6 the aspect employing the normal Diffie-Hellman protocol is shown. FIG. 6 shows the method employing the Hughes variant of the Diffie-Hellman protocol (which allows much of the principal's required computation to be done beforehand).

In FIG. 5, n is a large prime number equal to 2p+1 where p is also a large prime. The size of n should be sufficient to make the task of computing discrete logarithms in the finite field (0,n−1) computationally prohibitive.

Also, g is a small number which in the aspect is primitive modulo p. This means that if g is raised to all integer powers in the range (0,n−1) with the result reduced modulo n, this reduced result would cover all possible values in the range (0,n−1). It can be appreciated that, g need not be a primitive element, but must at least be a value that will generate a very large subgroup of the integers in the range (0, n−1).

In this aspect of the embodiment, the following steps are performed:

1. The principal 500 and its proxy agent 502 generate random values Xₚ 504 and Xₐ, 506 respectively, from which they compute corresponding values Yₚ 508, wherein Yₚ=g^{Xp} mod n and Yₐ 510, wherein Yₐ=g^{Xa} mod n, respectively, using exponentiation modulo n;

2. The principal 500 and proxy agent 502 exchange values Yₚ 508 and Yₐ 510;

3. The principal 500 and proxy agent 502 compute values Kₚ 512, wherein Kₚ=Yₐ^{Xp} mod n and Kₐ 514, wherein Kₐ=Yₚ^{Xa} mod n, respectively, using exponentiation modulo n. This establishes a composite session key common to both the client and the server where the client and the server each provide one portion towards construction of the composite key, where said composite key cannot be constructed by any other party not knowing one of the two provided portions. If there has been no interception and modification of messages Yₚ and Yₐ, agent 502 and server 500 will compute identical values Kₚ and Kₐ, i.e., Kₐ=Kₚ and this common value is called Kₛ;

4. Principal 500 and proxy agent 502 now each compute a secure hash value of their previously computed K value (Kₚ and Kₐ respectively), and encrypt the hashed value H (Hₚ 516 and Hₐ 518 for principal 500 and proxy agent 502, respectively) under the time-limited secret Z to produce a validation message V (Vₚ and Vₐ for principal and proxy agent, respectively). The encryption of Hₐ 518 by the proxy agent 502 acts as its signature.

5. The proxy agent 502 then returns its validation message Vₐ 522 to principal 500 (and the principal 500 can optionally send its validation message Vₚ 520 to the proxy agent);

6. If principal 500 receives validation message Vₐ 522 within the time limit T (that is, within time T from the time at which a clock started on the proxy agent's secret-keeping ability), it then compares it to its own validation message Vₚ 520. If there is a match, the principal is assured that it has in fact exchanged secret session key Kₛ with the intended proxy agent, and not with an impostor (i.e. any party that cannot discover secret Z within time limit T). The server then encrypts the secret key S 218 under the shared secret KS to form message W, and sends that to the proxy agent. If the validation message Vₐ is, however, not received before time T elapses, the server aborts the protocol; and

7. The proxy agent uses K, to decrypt W and recover secret S. This completes the transfer of secret S.

It can be appreciated that principal 500 may be equivalent to server 102 and proxy 502 may be equivalent to RA 106, or to Launcher 206.

In yet another aspect of the embodiment, a method for multiple independent accesses to a server is provided. Using the standard server-side digital rights management paradigm, software licenses are necessarily associated with specific machines. The following method allows for portability of machine-specific licenses from workstation to workstation.

The server co-ordinates use of software installed on the PCs. It responds to authentication requests, accesses a server-side database to determine software legitimacy and coordinates access control with the client-side software module. In the preferred embodiment, the server is object-oriented, comprising a modular arrangement of processes. The object classes thereof mimic conceptual components of a known software licensing system.

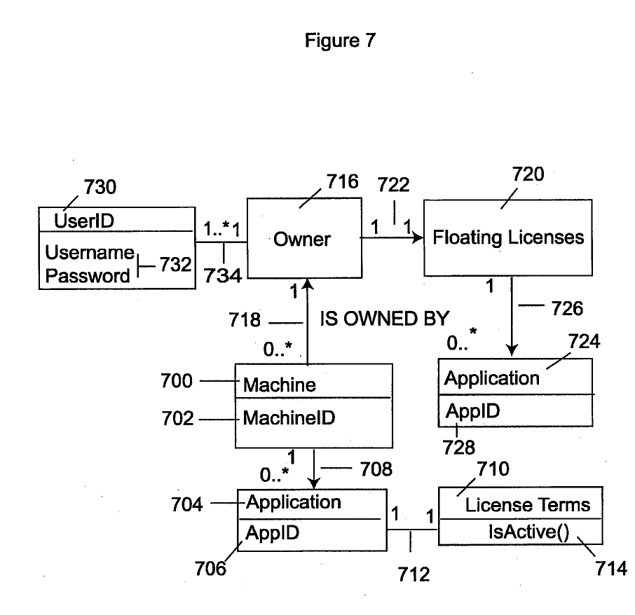

Referring to FIG. 7, a class-hierarchy enabling multiple accesses is shown. The class hierarchy consists of:

an owner 716 (comprising a collection of Machine objects 700 and a FloatingLicenses object 720);

Machine objects 700 (comprising collections of Application objects);

FloatingLicense objects 720 (comprising collections of ApplicationLicenses 724 owned by a user, but not affixed to a Machine);

Application object 704 (comprising a LicenseTerms object 706); and

UserID objects 730 (specifying a legitimate user in connection with the Owner of the machines).

Machine object 700 is the central object of the embodiment, and the first one accessed by the database upon initiation of an authentication request from the client. The primary database search key is the MachineID 702.

The Initial request from the client contains the AppID of the application attempting to launch, and the MachineID 702 of the machine attempting to launch it. MachineID 702 itself is in the preferred embodiment a combination of i) an identifier unique to the database serving the client; ii) a sequence number maintained by the database's authorization server; and iii) a large pseudo-random number to make MachineIDs unpredictable. At every authorization contact of the client with the server, the sequence number portion is incremented, the large pseudo-random number portion is modified to a new pseudo-random value, and the resulting new client identification code is updated in both the server database and at the client.

Machine objects contain a collection of application objects 704 in a one-to-many relationship (noted by link 708), which are uniquely identified by AppID 706. The AppID 706 is a unique identifier for a single version of a software application produced by a vendor. There can be any finite number of applications associated with a Machine, or none at all. An application object 706 represents a software license associated with that application. By adding an application object 706 to the collection in a Machine object 700, the application license may be validated on that machine, pursuant to the qualification of licensing terms. LicenseTerms objects 710 are associated on a one-to-one basis with Application objects 704, as noted by link 712. A LicenseTerms object 710 is a self-contained, self-executable set of instructions for determining whether a software license is valid to be launched on a given machine. Data regarding license validation criteria, as well as current standing in the license, are stored in LecenseTerms object 710, including criteria for licensing options available to the user for the given Application. The important feature of the LicenseTerms object 710 is the IsActive( ) task 714, which returns true if the licensing conditions are met for a particular launch, and false if not.

While the system ties a software license to a specific machine via Machine object 700 and its Application objects 704, it is important to support the transferability of licenses from one machine to another. Ease of transfer of licenses between machines must be balanced with control and tracking of where licenses reside (i.e. on which machines) and ownership of the machines. To this end, the Owner object 716 is a collection of machines owned by the same individual. This is represent by a many-to-one link as noted by link 718. License portability is effected by the user via the Owner model; licenses that are purchased are associated with the owner through a FloatingLicense 720 before they are tied to a given machine. There is a one-to-one relationship between Floating License 720 and Owner 716 as shown by link 722. The FloatingLicense object 720 is a variant on the Machine object 700. There is a one-to-many relationship between Floating License 720 and ApplicationCollection object 724 as shown by link 726. The FloatingLicense object 720 does not contain members representing a MachineID 702. It is essentially a collection of currently unused licenses purchased by the owner. Any given Owner has only one FloatingLicenses object 720.

When a license is first associated with an Owner it is not associated with a Machine. All licenses associated with an Owner that are not yet associated with one of its Machines are instead associated with its FloatingLicenses object 720. When the software application for which the license was bought is run, the license is found in the FloatingLicenses 720 and transferred to the given Machine.

A User object 730 simply stores a name and password 732 providing access to an Owner object 716. This is a many-to-one relationship as shown by link 734. The reason for implementing a distinction between user and owner is to provide for multi-user access for large corporations or bodies in which it is important to distinguish between the owner of a license and individuals acting on behalf of that owner. It can be appreciated that other features of the server software may provide restricted access capabilities, granting access to certain users and not to others.

In use the server-side database is catalogued by MachineID 702. These MachineID 702 entries match pointer values which point at the appropriate Machine objects 700. Sinc e authentication requests are performed using MachinelD numbers as the validation criteria, this allows the entire semi-radial object structure to be accessible through a standard database query.

Typical on-line authentication request consists of:

1. Lookup Machine object 700 with associated MachineID 702

2. Navigate to Machine object 700

3. Lookup Application object 724 within Machine object 700 with associated AppID 724

4. Navigate to Application object 724

5. Navigate to LicenseTerms 710 to determine if license is still valid

6. Launch contingent to validity of license

7. Update the value of the dynamic MachineID 702.

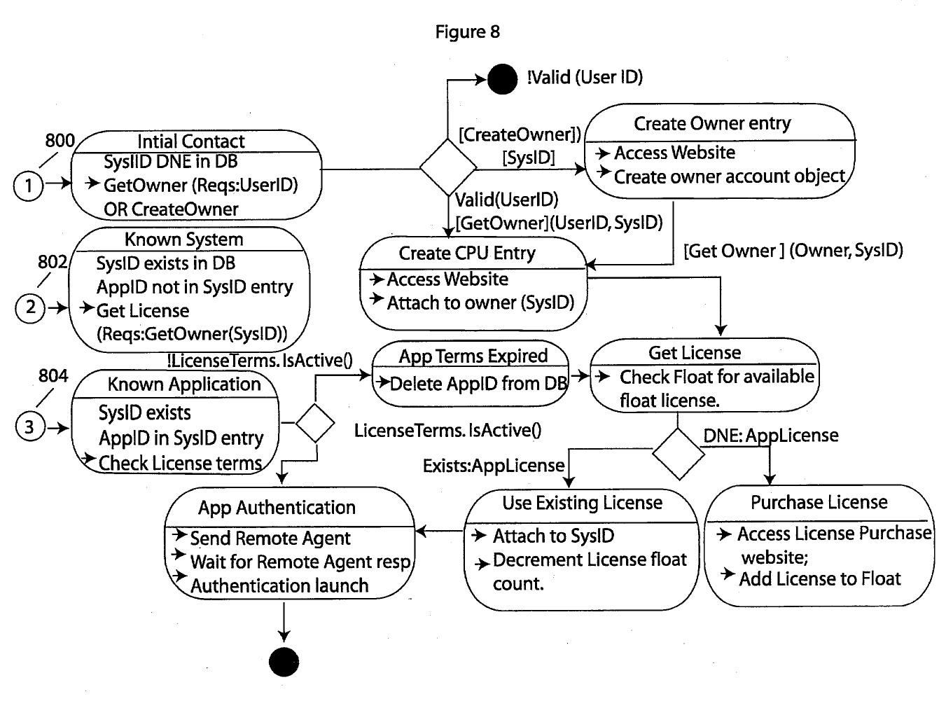

Referring to FIG. 8, one of these paths are followed when a user signs onto the system: (i) First contact, (ii) first use of software and (iii) normal launch.

In a first contact scenario 800 by a machine is made with the system, there is no record of the user's system in the database. The client side compiles MachineID 702 which does not match up with any database entries. Thus, ApplicationID 728 must be associated with an Owner 716. The system will ask for a username and password. If the user has one, the user enters it, and the user is taken to the software vendor's purchase website to negotiate payment for the software, or to enter a registration key if the software was bought in a store. The vendor's website alerts to the system of the purchase by the Owner of a new license, which is stored in the FloatingLicenses object 720.

If the user has no username, the user is taken to the server website for assignment of a username and password.

In a first use of software, at node 802 an existing user is attempting to run a new piece of software. Because the MachineID 702 is already stored in the database and is associated with an Owner object 716, no username or password is necessary. However, the ApplicationID 706 given by the client will not match an Application stored in that Machine object 700; thus the system must attempt to locate a license owned by that user or ask the user to purchase/register one.

The server checks the FloatingLicenses object 720 to determine if a license has been purchased. If the user has already negotiated purchase or registration with the vendor website, the license is transferred from the FloatingLicenses object 720 to the Machine on which the user is attempting to launch. Otherwise, the user is taken to the software vendor's website (again, to negotiate license purchase or to register a store-made purchase), at which point the new license is stored in the FloatingLicenses object 720.

In a normal launch, information on MachinelD 702 provided to system by the client exists in the database, and the ApplicationID 728 given by the client matches an Application within the Machine object 700. To ensure that the purchase license is still valid, the LicenseTerms object 710 is checked to ensure that the user still should have access to the Application. If isActive( ) task 714 of the LicenseTerms object 710 returns false, the user is no longer allowed to access the application, and the Application object 706 is deleted from the Machine object 700. Otherwise, an access normal run is approved. The LicenseTerms object 710 may be updated to reflect this access.

Still yet another aspect of the embodiment provides a method by which the communications connection between a client and an authentication server may be accessed by an alternative conduit provider in delivering supplemental data content, such as advertising, to the client.

The method includes a web page interface, allowing companies to exchange advertisement spaces of their software applications and advertise their own products. It also allows other non-software/software companies (External Advertisers) to purchase advertisement spaces that belong to the server community.

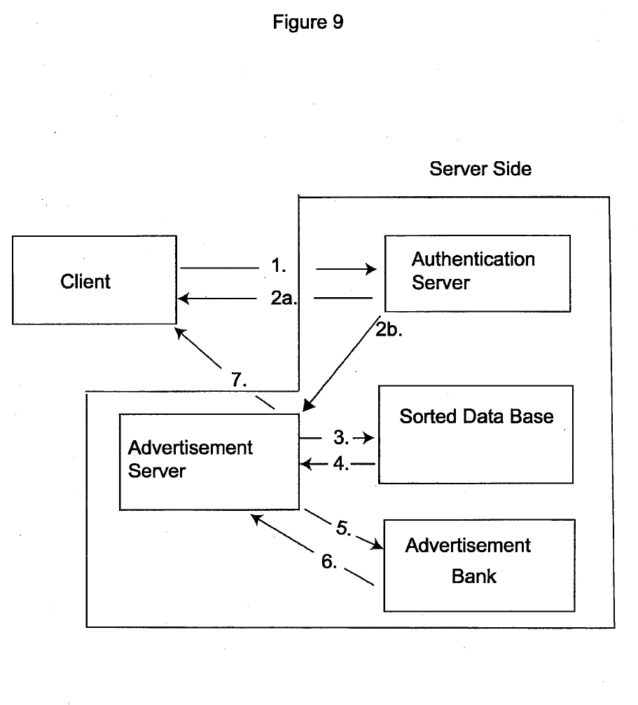

Referring to FIG. 9 in a distributed advertising system, a plurality of clients would be linked to an application server through a communications network. Also an advertising server is associated with the networks, which provides a series of advertisements or other communications to selected clients.

The following procedure is used to distribute advertising.

1. Client Software (i.e. primary data content) contacts authentication Server to request for authentication.

2. a) an authentication process is performed (which may be as described above).

b) If an Advertisement is allowed for this run of executing software (Determined by the frequency of advertisement occurrence as determined by individual Software Vendors), the Authentication Server contacts the Advertisement Server and starts the Advertisement process, passing the Software Application Number to it.

3. Advertisement Server looks up the sorted database with the Software Application Number.

4. Advertisement Server obtains the appropriate Advertisement Number.

5. Advertisement Server contacts the Advertisement Bank with the Advertisement Number.

6. The Advertisement matching the Advertisement Number is passed back to the Advertisement Server.

7. The Advertisement is downloaded to the Client machine and executed.

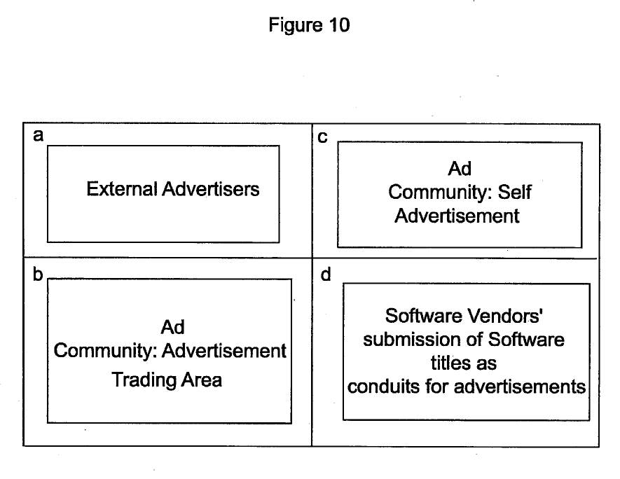

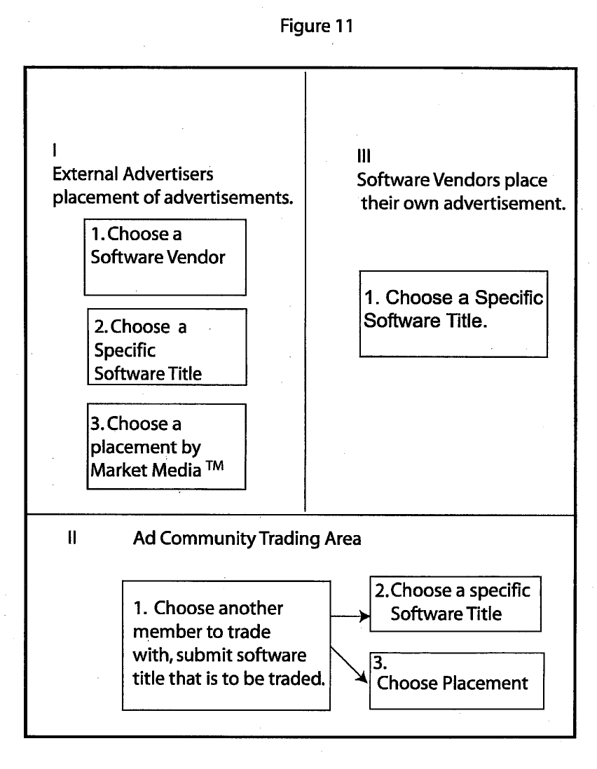

Referring to FIGS. 10 and 11, the distribution space of a Software Vendor consists of a record of times in which an advertisement can be send to the Client machine during authentication of that Software Vendor's software. This distribution is divided into three sections: advertisements which allow Software Vendors to perform their own advertisements; advertisements that are traded among the server; and advertisements from external advertisers.

FIG. 10 shows the contents of the first Web page in which to advertise. User has four choices of selecting a sub-domain. a) is for external advertisers, b) is for a group who wishes to trade advertisements, c) is for Software Vendors' submission of advertisements for its own products placing with own Software titles, and d) is Software Vendors' submission of Software titles as conduits for advertisements.

External advertisers will be directed to the contents as shown on FIG. 11, where there will be three choices. The external advertiser can place his/her advertisement by software vendor, software titles, or by the sorted data.

If the user chooses b), server the user will first be asked to choose another member to trade with and submit a software title to be traded. Then, the user selects a software title for advertisement or placement. First, the system will seek other members who are searching for advertisement space to exchange and verify if there are any that is requested by this member. If there are, the system will check if these other member request the advertisement that this member had submitted. It there is a match, the system immediately places the advertisement submitted by both parties into the advertisement spaces and emails will be sent to both parties' account Web page. If not, the system will send out a priority email to notify the other member who this user wishes to trade with. The other member can then check this email in his/her own account and confirm the transaction on his/her account Web page.

If the system user chooses to advertise his/her companies own product using its own Software, he can do so by selecting c). The system will direct the user to a Web page where he can choose and manage the advertisement spaces (software titles) where he/she can put the advertisement. This is illustrated in FIG. 11.

If the system user chooses to put up an advertisement space of either exchange or sale to external advertisers he/she may do so by choosing d). The system user can simply go to his/her company's account Web page where he/she can submit his/her advertisement space.

It can be appreciated that while the above aspect of the preferred embodiment is described in the context of distributing advertisements over a network, it will be appreciated that other content may be distributed over a network using the same aspect of the embodiment.

It is noted that those skilled in the art will appreciate that various modifications of detail may be made to the present embodiment, all of which would come within the scope of the invention.

1. In an insecure communications network comprising a client and server communicating through said insecure communications network, a method of providing controlled access to digital works over said insecure network, said method comprising:
employing a client identification code that uniquely identifies said client to said server,
employing a content identification code to identify said digital work;
transmitting from said client to said server said client identification code; and
evaluating access rights of said client to said digital work at said server by checking said client identification against a database comprising access rights for a plurality of clients for said digital work; and if said access is authorized, transmitting to said client a secret or authorization code used to gain access to said digital work.

2. A method for creating a client identification code by:
composing the identification code as a concatenation of a fixed identifier unique to a server, a changeable sequence number incremented by the server, and a changeable pseudo-random number; and
at every authorization contact of a client with the server, updating the client and server database with a modified identification code.

3. In an insecure communications network comprising a client and server communicating through said insecure communications network, a method of transmitting in encrypted fashion to said client a secret, said method comprising:
establishing a composite session key common to both said client and said server where said client and said server each provide one portion towards construction of the composite key, where said composite key cannot be constructed by any other party not knowing one of the two provided portions;
encrypting said secret with said composite session key to form an encrypted secret;
transmitting from said client to said server an authentication message, where said authentication message is known only to said client and said server within a time limit, and to no other party within said time limit;
transmitting said encrypted secret from said server to said client if and only if said authentication message is valid and is received by said server within said time limit; and
decrypting said encrypted secret at said client using said session key to recover said secret.

4. In a software license environment for multiple copies of different digital works and at least one machine, a database association comprising
a first record for a digital content license owner;
a second record for digital works licensed by said owner which have not yet been assigned to a machine;
a third set of records for machines controlled by said owner;
for each machine in said third set, a set of records of installed digital works associated with said each machine; and
for each record in said set of records of installed digital works a record for a license relating to said installed digital works,
wherein said database allows manipulation and access of records therein when (i) a record for said owner does exist in said database and a query is being made regarding status of said owner to said database; (ii) a record for said owner exists in said database and said owner is attempting to access a digital work for which a record is not in said database; and (iii) a record for said owner exists in said database and said owner is attempting to access a digital work for which there is a record in said database.

5. In a communications network where a client communicates with a plurality of types of servers, a method of distributing supplemental data content from said server to said client or other clients in said network, said method comprising:
when said client is executing a program, contacting an authentication server to determine as part of the license terms whether said supplemental data content should be provided to said client; and
retrieving from a data content server said data content and transmitting said data content to said client for display on said client.

6. The method of claim 1, further comprising:
providing a software module at the client for coordinating access-rights checking with the server, said software module being attached to form an integral part of any software-application digital works.

7. The method of claim 1, wherein the step of transmitting is performed when on-line connection to the authorization server is possible.

8. The method of claim 7, further comprising:
when on-line connection to an authorization server is not possible:
evaluating at the client a set of time-limited access rights stored locally, said locally stored access rights having been previously digitally signed and transmitted by the server, and if said access is authorized, allowing off-line access to the digital work.

9. The method of claim 1, further comprising:
updating the dynamic client identification code so that copied off-line access rights will be invalidated at subsequent server contacts.

10. The method of claim 1, further comprising:
leaving in local storage at the client a set of access rights digitally signed by the server to allow subsequent off-line usage.

11. The method of claim 1, further comprising:
encrypting the secret or authorization code prior to transmitting it.
